(19) United States
(12) Patent Application Publication
(10) Pub. No.: US 2004/0107622 A1
(43) Pub. Date: Jun. 10, 2004

(54) Waterfowl lure

(76) Inventor: Matthew J. Steele, Boulder, CO (US)

Correspondence Address: Bryan A. McMichael, 2828 Keyston Drive, Evergreen, CO, 80439, US

(21) Appl. No.: 10/314,481

(22) Filed: Dec. 9, 2002

(51) Int. Cl. A01M 31/06

(52) U.S. Cl. 43/2

(57) ABSTRACT

A waterfowl lure used to attract waterfowl to a general area, comprising of a ground covering with an artistic print on its top face that mimics unfrozen water or a food plot, the purpose of which is to simulate a natural waterfowl habitat. The print may also contain portrayals of living waterfowl. The ground covering can be attached to any type of underlying surface, whether land, snow or frozen water.

### CROSS REFERENCE TO RELATED APPLICATIONS

Not applicable

### BACKGROUND OF THE INVENTION

This invention relates to the luring of waterfowl to any general area during any season. Traditionally, waterfowl lures were in the form of waterfowl decoys. These decoys were commonly three-dimensional life-like models of a particular species of waterfowl, which were placed in water or in a food plot to mimic living waterfowl. Living waterfowl were then attracted to the general area of the decoys. The general problem with traditional waterfowl lures is that the decoys had to be placed in non-frozen water or in a food plot. Further, traditional geese decoys were expensive, large and difficult to deploy effectively. Therefore, traditional waterfowl lures were minimally effective during a freezing winter, an area that lacked water, or an area not a food plot.

When seasons and topography allowed the use of traditional waterfowl decoys, it was common practice to arrange several dozen decoys in an area of a natural waterfowl habitat. A significant problem with using this many decoys was the weight and bulk involved in transporting and deploying the decoys to and from the site. It was quite time consuming to deploy several dozen decoys in an appropriate display that would attract living waterfowl. Further, the area of deployment had to contain non-frozen water or the food or nourishment sought by waterfowl.

### SUMMARY OF THE INVENTION

This invention utilizes a large ground covering that is attached over land or frozen water. On the top-side of the ground covering is an artistic print that resembles unfrozen water, with some prints having waterfowl swimming or landing thereon. The artistic print of unfrozen water may be that of a river, channel, pond, or lake, complete with a vegetated or snowy bank. Other prints will mimic an unfrozen hole in the ice of an otherwise frozen pond or lake. Additional prints will mimic waterfowl food plots, such as a harvested cornfield. The invention can vary depending upon the user's need. The object of this invention is to simulate an unfrozen waterfowl habitat or a typical food plot that will lure living waterfowl to the general vicinity of the ground covering. Waterfowl hunters and waterfowl photographers will benefit from this invention.

This invention solves the previous problems of luring waterfowl, using traditional waterfowl decoys, during a freezing winter, an area lacking water, or an area not a food plot. This invention can be deployed in any season and over land, snow or frozen water. Further, by virtue of mimicking food plots or non-frozen water, this invention will make barren areas, or areas not otherwise attractive to waterfowl, capable of luring waterfowl.

This invention also alleviates the bulk and burden commonly associated with transporting and deploying several dozen traditional decoys. This invention can be folded up to a compact size, which is easier to transport. This invention can also be made using lightweight synthetic cloth.

Finally, this invention is quicker and easier to deploy than traditional decoys because deployment of this invention simply involves attaching the ground covering to the underlying surface.

### BRIEF DESCRIPTION OF THE DRAWINGS

Not applicable

### DETAILED DESCRIPTION OF THE INVENTION

The preferred embodiment of this invention utilizes a 12-ounce, stretchable, reinforced outdoor vinyl mesh, which is to become the ground covering. This vinyl mesh is commonly used for outdoor billboards and large advertisements placed on the exterior of buildings. Benefits of this material include it being readily obtainable, non-reflective, waterproof, resistant to ultraviolet radiation, and that an artistic computer-generated print can be readily applied. This material can also be folded for compact storage and transportation. Further, because the vinyl mesh consists of small interwoven vinyl strips, this material can withstand wind. Canvas would also suffice as an alternative to the vinyl mesh, with some of the same benefits as the vinyl mesh. Other materials, from natural fabrics like cotton, to synthetic polymers like nylon, will also suffice.

The ground covering should contain a means to attach it to the underlying surface, whether the underlying surface be land, snow or frozen water. The preferred means of attaching the ground covering utilizes eyelets placed along the outside edge of the ground covering at regularly spaced intervals. The eyelets should be made of non-reflective material, or painted with non-reflective paint, so waterfowl will not be distracted. These eyelets allow the user to stake or tie the ground covering to any type of underlying surface. These eyelets also allow the user to adjacently join two or more ground coverings to create a single, larger ground covering. Velcro and/or buttons may also be sewn into the outside edges of a ground covering to assist in adjacently joining two or more ground coverings. Besides eyelets, a user may sew sleeves into the outside edge of the ground covering. The user could then thread rope or poles through the inside of the sleeve, and then use to the rope or poles to attach the ground covering to the underlying surface.

The size and shape of this ground covering will vary depending upon the user's needs. The shape need not be square or rectangular. The five most common uses of this ground covering will be to simulate an unfrozen river, an unfrozen pond or lake, an unfrozen channel, an unfrozen hole in an otherwise frozen pond or lake, or a food plot. The user will select the particular simulation depending upon the natural environment in which the user desires to place the ground covering. For a ground covering mimicking an unfrozen river, the preferred size is a rectangular 14 feet by 48 feet because this is a common size for outdoor billboards, which makes this shape readily obtainable. A shape larger and less narrow, such as 30 feet by 60 feet, work well for ground coverings mimicking an unfrozen pond, lake, channel or an unfrozen hole in an otherwise frozen pond or lake. These and larger sizes, dependent upon the user's needs, suffice for mimicking a food plot.

The top face of the invention will have the artistic print that attracts waterfowl. The preferred method of generating this print utilizes a color, computer generated, digital graphic at a resolution between 70 to 600 dots per inch. An effective alternative is to use a four-color screen-printing process. Alternatively, the invention can be manufactured by dying the ground covering a particular color to simulate water, then enhancing the edges of the ground covering with a pattern mimicking vegetated ground, frozen water, a food plot, or the surrounding environment. A print may also be applied using a more traditional paint and brush method. The print, when applied to the ground covering, should be opaque when viewed from a distance, but may be transparent when viewed up close (as will be the case if a vinyl mesh is used as the medium). The print may contain waterfowl of one or some particular species (depending upon the type of waterfowl the user wishes to lure), portrayed as swimming, landing, or flying. The purpose of adding waterfowl to the print is to increase the realism of the print and to attract waterfowl that tend to flock. A user could also place traditional three dimensional waterfowl decoys on the print. For prints mimicking a river, channel, pond or lake, the preferred print will contain a vegetated shoreline that resembles the natural vegetation where the ground covering is to be used. For prints mimicking an unfrozen hole in an otherwise frozen pond or lake, the edges of the print should resemble the natural frozen water where the ground covering is to be placed. The interior of this type of print will resemble unfrozen water. For prints mimicking a food plot, the print should resemble the particular waterfowl's food source, which is commonly a field of alfalfa, winter wheat, or harvested corn. For any print, it is important that the overall effect of the print resemble the particular season and environment in which it is to be used.

I claim:

1. A device for luring waterfowl comprising of a ground covering to be placed over land, snow or frozen water, with said ground covering having an artistic print on its top face, with said artistic print simulating a natural waterfowl habitat.

2. A device for luring waterfowl as recited in claim 1 wherein said ground covering is made from a natural fiber, a synthetic fiber, or a blend of natural and synthetic fibers.

3. A device for luring waterfowl as recited in claim 1 wherein said ground covering is made from an outdoor vinyl mesh.

4. A device for luring waterfowl as recited in claim 1 wherein said ground covering is made from canvas.

5. A device for luring waterfowl as recited in claim 1 wherein said ground covering has a means for attaching said ground covering to the underlying surface.

6. A device for luring waterfowl as recited in claim 5 wherein said means are eyelets along at least one edge of said ground covering.

7. A device for luring waterfowl as recited in claim 6 wherein said eyelets are non-reflective.

8. A device for luring waterfowl as recited in claim 5 wherein said means is a hollow sleeve along at least one outside edge of said ground covering.

9. A device for luring waterfowl as recited in claim 1 wherein said ground covering has a means for attaching said ground covering adjacently to one or more other said ground coverings.

10. A device for luring waterfowl as recited in claim 9 wherein said means are eyelets along at least one edge of said ground covering.

11. A device for luring waterfowl as recited in claim 10 wherein said eyelets are non-reflective.

12. A device for luring waterfowl as recited in claim 9 wherein said means is a hollow sleeve along at least one outside edge of said ground covering.

13. A device for luring waterfowl as recited in claim 9 wherein said means is a Velcro strip along at least one edge of the ground covering.

14. A device for luring waterfowl as recited in claim 9 wherein said means are buttons placed along at least one edge of the ground covering.

15. A device for luring waterfowl as recited in claim 1 wherein said natural waterfowl habitat of said artistic print contains a portrayal of non-frozen water.

16. A device for luring waterfowl as recited in claim 1 wherein said natural waterfowl habitat of said artistic print mimics a food plot.

17. A device for luring waterfowl as recited in claim 1 wherein said artistic print also contains portrayals of waterfowl.
